(19) United States
(12) Patent Application Publication
(10) Pub. No.: US 2021/0078546 A1
(43) Pub. Date: Mar. 18, 2021

(54) VEHICLE TIRE INFLATION COMPRESSOR FOR POWERED DATA PORTS

(71) Applicant: ILLINOIS TOOL WORKS INC., Glenview, IL (US)

(72) Inventors: Martin Patrick Spindler, Herdwangen (DE); William Craig Keller, Medway, MA (US)

(73) Assignee: ILLINOIS TOOL WORKS INC., Glenview, IL (US)

(21) Appl. No.: 17/107,162

(22) Filed: Nov. 30, 2020

Related U.S. Application Data
(63) Continuation-in-part of application No. 16/432,313, filed on Jun. 5, 2019.
(60) Provisional application No. 62/688,204, filed on Jun. 21, 2018.

(51) Int. Cl. B60S 5/04; B29C 73/16

(52) U.S. Cl. CPC B60S 5/046; B29L 2030/00; B29C 73/166

(57) ABSTRACT

A device and method for dispensing air and/or sealant to a tire of a vehicle. Power supply for the air compressor is obtained via powered USB instead of the typical 12 V cigarette lighter connector. The position of the tire which is being inflated can also be determined via the data interface of the USB port. By communication between compressor and the vehicle systems interface, the compressor can automatically switch off when the recommended tire pressure has been reached.

### CROSS REFERENCE TO RELATED APPLICATION

This application is a continuation-in-part of U.S. patent application Ser. No. 16/432,313, filed on 5 Jun. 2019, which claims the benefit of U.S. Provisional Application, Ser. No. 62/688,204, filed on 21 Jun. 2018. This parent application is hereby incorporated by reference herein in its entirety and are made a part hereof, including but not limited to those portions which specifically appear hereinafter.

### BACKGROUND OF THE INVENTION

### Field of the Invention

This invention relates to a device for dispensing air and/or tire sealant by a pressure source, and more particularly a portable vehicle tire inflation device that can be powered via vehicle data ports.

### Description of Prior Art

There are many different forms and designs of vehicle tire inflators known and currently available on the market. They are primarily used for introducing air and/or tire sealant into low pressure tires or damaged tires. Portable tire inflators are powered by the common 12 V direct current (DC) connectors, such as the ubiquitous cigarette lighter plug (e.g., as defined in ANSI/SAE J563) for the vehicle cigarette lighter receptacle or socket.

As vehicle technology and electronics improve, there is a continuing need or opportunity for improved vehicle accessories that interconnect with these new vehicle systems.

### SUMMARY OF THE INVENTION

The present invention is directed to a device for dispensing air and/or sealant, such as a mini-compressor or inflator, with a pressure source powered and/or controlled through a data communication port and cord, such as a powered Universal Serial Bus (USB) and USB cord, instead of the usual 12 V connector (cigarette lighter). While suitable for various inflation needs, the device is particularly useful for portable or emergency vehicle dispensing/inflator devices, and is powered and/or controlled via the vehicle's data communication port (e.g., USB).

In embodiments of this invention, during inflation or dispensing, the status of the object inflated, e.g., the vehicle tire, can be monitored and/or determined via the data interface of the vehicle USB port. By communication between compressor and the vehicle electronics systems (e.g., RDC or ECU), the compressor can switch off when the recommended tire pressure has been reached.

In some embodiments of this invention, additional comfort functions can be realized, such as by help of the vehicle entertainment system. For example, the remaining filling time can be calculated and displayed on a screen of the inflator and/or via a vehicles user interface display. Or, depending on the course of the filling procedure, collective system can predict whether the tire can be repaired by help of the compressor. In case of need, help by a third party can be ordered without delay.

These and other benefits can be obtained by a device for dispensing air and/or sealant to a tire of a vehicle, that includes a pressure source, a dispenser outlet connected to the pressure source, a connector element, and a control module in communication with each of the connector element and the pressure source. The connector element, e.g., a data and/or power cord, is desirably configured to connect to a vehicle data communication port (e.g., USB or equivalent) to obtain inflation information and/or power. The data communication element desirably is a powered data communication port, whereby the control module can draw operational power for the dispensing device via the powered data communication port.

In embodiments of this invention, the control module obtains tire inflation values from a vehicle tire pressure monitoring system and/or other sensor systems, such as vehicle load sensors. The device can automatically operate (e.g., turn on) upon receiving a low tire inflation value from the vehicle tire pressure monitoring system, and automatically cease inflation upon automatically determining a proper inflation.

In embodiments of this invention, the device for dispensing air and/or sealant to a tire of a vehicle including a powered data communication port, includes a pressure source integrated with the device; and a control module configured to connect to the powered data communication port to power and control the pressure source. The control module can be in the device housing or in a connector element for the vehicle port, and can includes a logic circuit configured to receive information about pressure and temperature originating from vehicle tire pressure sensors and/or an electronic system of the vehicle.

The device generally includes a power supply cord having a plug that fits into the data communication port. In embodiments of this invention, the control module is contained within the plug (USB), and configured to provide and stop power from powered data communication port through the power supply cord to the pressure source.

The invention further includes a device for dispensing air and/or sealant to a tire of a vehicle, the vehicle including a powered data communication port. The device includes a pressure source, a dispenser outlet connected to the pressure source, and a power supply cord including a first end that is connected or connectable to the pressure source and a second end opposite the first end, the second end including a connector element configured to connect to the powered data communication port to obtain power. The connector element includes a control module configured to control a power supply to the pressure source through the power supply cord. Power and inflation data can be transferred from the data communication port to the control module via the connector element. Preferably, the control module is fully housed within the connector element, and contains all control logic configured to communicate with a computer system on the vehicle and to provide operational power to the device for dispensing air and/or sealant to the tire of the vehicle. In such embodiments, the power supply cord can be a two-wire power cable, without data communication cables.

The invention further includes a method for dispensing air and/or sealant to a tire of a vehicle. The method includes connecting a tire inflation or repair device to the tire, connecting the tire repair device to a data communication port of the vehicle, and powering the tire repair device dispensing via the data communication port of the vehicle. The method can further include automatically monitoring and/or controlling a tire inflation via data provided to the tire repair device by the vehicle via the data communication port.

The invention further includes a method for dispensing air and/or sealant including: connecting a tire repair device to the tire, connecting a connector element of a power supply cord of the tire repair device to a data communication port of the vehicle, the connector element including a control module, and the control module in the connector element operating the tire repair device dispensing via the data communication port of the vehicle.

### BRIEF DESCRIPTION OF THE DRAWINGS

The above-mentioned and other features and objects of this invention will be better understood from the following detailed description taken in conjunction with the drawings.

FIG. 1 is a representative illustration of a dispensing device according to embodiments of this invention in combination with a vehicle.

FIG. 2 illustrates a dispensing device according to one embodiment of this invention.

FIG. 3 illustrates a dispensing device according to another embodiment of this invention.

FIG. 4 illustrates a dispensing device according to another embodiment of this invention.

### DESCRIPTION OF PREFERRED EMBODIMENTS

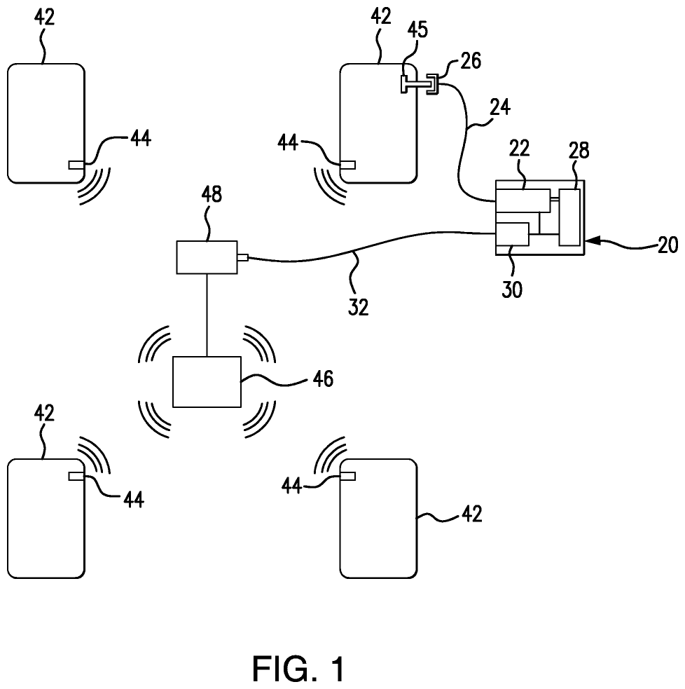

FIG. 1 illustrates a device 20 according to embodiments of this invention for dispensing air and/or tire sealant into tires 42 of vehicle 40. The vehicle 40 is representatively show as including four tires 42, each including a tire pressure monitoring system (TPMS) sensor 44. As currently known and implemented throughout the automotive industry, the TPMS sensors 44 communicate by any suitable connection, such as wirelessly, with the vehicle control computer system 46, such as the electronic control unit (ECU) or equivalent system or subsystem. The vehicle 40 further includes a data communications port 48, such as a powered USB port in combination with the computer system 46.

Device 20 includes a pressure source 22 that can be connected to the tire 44 by a dispenser outlet, shown as air hose 24 with any suitable end valve 26 to match the tire stem 45, such as a Schrader valve. The pressure source 22 is desirably embodied in the form of a compressor, and can optionally be paired with a sealant canister 28 for dispensing both air and tire sealant.

The device 20 further includes a module 30 configured to connect to the data communication port 48 of the vehicle 40 to power and/or control the pressure source 22. The module 30 connects via connector element 32 to obtain inflation information and/or power, such as a power and/or data cord. The connector element 32 has an end integrally connected (i.e., fixed) to the module 30, or can be a separate cord having a plug that fits into a corresponding socket in the device 20. Any suitable data and/or power connection can be used, depending on need and the vehicle components. Powered USB cords and sockets are preferred due to current inclusion within vehicle audio or other systems. Any suitable USB version and/or connector type, such as standard, mini, or micro Type A, B, or C, etc., can be used. As will be appreciated, other suitable data and/or power connectors such as Thunderbolt™ or Lightning™ cables, or combinations of any of the interfaces, can be used depending on need.

Embodiments of this invention use a powered USB or equivalent connection instead of the traditional and common 12V-DC-connectors, for supplying compressors with power. Additionally or alternatively (i.e., along with the traditional 12 V connector), data can be exchanged between the vehicle and dispensing device. In embodiments of this invention, the control module includes an integrated logical circuit, for example, to receive information about pressure and temperature originating from the tire pressure sensors and/or ECU. This information can be used as control parameters, such as to automatically control the device and the inflation process. The control algorithm(s) can optionally be executed on the vehicle systems, with the device receiving simple operational instructions (e.g., on/off).

In embodiments of this invention, the communication between the vehicle's systems and the compressor device would render obsolete manual displays of pressure by a manometer on the compressor. The complete control of the compressor can be realized by the vehicle and compressor electronics. Manual on/off-switches could also be omitted, as the device automatically starts inflation as needed when connected and ceases inflation upon automatically determining a proper inflation. The ability to reduce pressure may also be omitted, because the compressor cannot overfill the tire due to the communication with the vehicle.

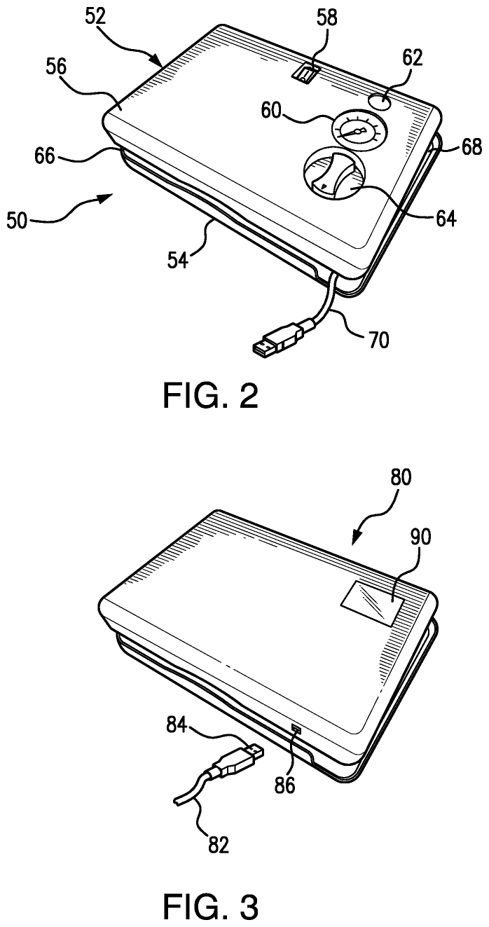

FIG. 2 shows a device 50 for dispensing air and/or tire sealant according to one embodiment of this invention. The device 50 can have internal components such as described in U.S. Pat. No. 9,914,271, herein incorporated by reference. The device 50 includes a housing 52 formed of a bottom receptacle 54 and a cover 56. The device of FIG. 2 shows a dispensing device, with traditional functional elements such as a switch 58 for switching the device on and off, a manometer 60 for measuring the pressure built up by the internal pressure source, a pressure release button 62 for releasing excess pressure, and a rotary switch 64 for actuating a valve for an optional sealant canister. Between the receptacle 54 and the cover 56, a circumferential slot 66 is provided into which a USB or equivalent cable 70 for powering or operating the device and/or a hose 68 for dispensing air and/or tire sealant can be wrapped and stored.

In FIG. 2, the USB cable 70 is fixed or integrated at one end to the device 50, similar to most current 12 V compressor power cords. FIG. 3 illustrates a further embodiment wherein the dispensing device 80 has a separate USB cord 82 that has a USB plug 84 that is removably attachable to a corresponding USB socket or receptacle 86 on the device 80 as the power supply port. The socket 86 is shown in a side wall of the housing, but can be placed anywhere on the device, such as the top surface, depending on need or other design considerations.

FIG. 3 also illustrates a device without the functional elements for the user operation shown in FIG. 2. The device of FIG. 3 operates automatically with the vehicle system(s) to turn the compressor and/or sealant on and off. The device 80 is shown only with an optional display screen 90, which can display information such as, without limitation, a pressure value, a remaining inflation time, warning messages, sealant amount, and/or other information.

In embodiments of this invention, the power control logic is integrated with the connector element, such as within the connecter plug of the power supply cord that fits into the powered data communication port of the vehicle. In this manner, the compressor device itself can be a ‘dumb’ device that does not require any logic or other smart control features. The control module in the power supply cord acts as the switch to activate/deactivate the pressure source (e.g., compressor) via introducing/stopping power from the powered data communication port of the vehicle.

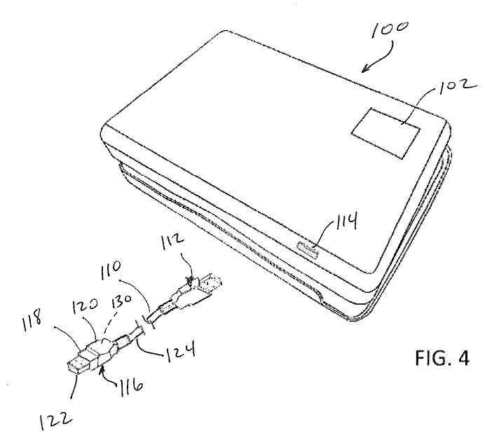

FIG. 4 illustrates a dispensing device 100, also without the functional elements for the user operation shown in FIG. 2. The device of FIG. 4 operates automatically with the vehicle system(s) to turn the compressor and/or sealant on and off. The device 100 is shown only with an optional display screen 102, which can display information such as, without limitation, a pressure value, a remaining inflation time, warning messages, sealant amount, and/or other information. The device 100 includes a power supply cord 110, with a first end 112 having a USB or equivalent plug corresponding to USB port 114 on the device 100. Alternatively, the first end 112 can be integral or ‘hard-wired’ to the electro-mechanical components of the device 100, namely the pressure source, any powered valves/switches, and/or the optional display screen components/controls.

The power supply cord 110 includes a second end 116 with a connector or plug 118 that connects to a powered data communication port of the vehicle. As shown, the plug 118 is also a USB connector for a USB port. The plug 118 includes, at least partially and preferable all of, the control module for starting and stopping the electric operational power to the device 100. As shown, the plug 118 includes an optional larger plug housing 120 to accommodate the control module 130. The control module is disposed between a USB connector 122 extending from the housing 120, and the power cable 124 extending to the device 100. With all the power control logic on/in the plug, the cable 124 can be a standard two-wire cable and the compressor device 100 can be a standard compressor of the applicable performance class (limited to the performance of the USB-PD power supply). This has additional benefit of reducing the overall cost for the device, and not needing a shielded data/communication channel in the cable to the device. The cable that powers the compressor device is a standard cable, but the plug on the cable going into the USB socket in the vehicle carries all the control logic for TPMS communication and power management, such as described above.

The automated dispensing devices of this invention can include any necessary circuitry, data processors, memory components, encoded software instructions, and/or control algorithms to obtain vehicle and tire inflation data and values through the vehicle data communication port. The vehicle system(s) can additionally include necessary coordinating software, logic circuits, etc. to send information obtained from, or control instructions based upon, the TPMS and/or load sensors to the inflator for operation. In embodiments of this invention, the dispensing device can determine that a puncture needs sealing based upon a detected rate of inflation, or lack of expected inflation, and automatically dispense sealant.

Thus the invention provides a portable air and/or sealant dispensing device engineered for advances in vehicle systems. The dispensing devices of this invention reduce user error and allow for less manufacturing expense due to fewer required functional components.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A device for dispensing air and/or sealant to a tire of a vehicle, the vehicle including a powered data communication port, the device comprising:
a pressure source integrated with the device; and
a control module configured to connect to the powered data communication port to power and control the pressure source.

2. The device of claim 1, wherein the control module comprises a logic circuit configured to receive information about pressure and temperature originating from vehicle tire pressure sensors and/or an electronic system of the vehicle.

3. The device of claim 1, further comprising a power supply cord having a plug that fits into the data communication port.

4. The device of claim 3, wherein the control module is contained within the plug.

5. The device of claim 4, wherein the control module is configured to provide and stop power from powered data communication port through the power supply cord to the pressure source.

6. The device of claim 4, further comprising a power supply port for receiving a second end of a power supply cord.

7. The device of claim 4, wherein the powered data communication port is a powered universal serial bus (USB), and the device comprises at least one of USB power cord or a corresponding USB.

8. The device of claim 1, further comprising a housing containing the pressure source and the control module, wherein the control module is in controlling combination with the pressure source to dispense the air and/or sealant.

9. The device of claim 1, wherein the control module obtains inflation values via the data communication port during the dispensing.

10. The device of claim 9, wherein the device automatically ceases inflation upon automatically determining a proper inflation.

11. The device of claim 9, further comprising an inflation pressure status display.

12. A device for dispensing air and/or sealant to a tire of a vehicle, the vehicle including a powered data communication port, the device comprising:
a pressure source;
a dispenser outlet connected to the pressure source;
a power supply cord including a first end that is connected or connectable to the pressure source and a second end opposite the first end, the second end including a connector element configured to connect to the powered data communication port to obtain power; and
the connector element including a control module configured to control a power supply to the pressure source through the power supply cord.

13. The device of claim 12, wherein power and inflation data are transferred from the data communication port to the control module via the connector element.

14. The device of claim 12, wherein the control module is fully housed within the connector element, and contains all control logic configured to communicate with a computer system on the vehicle and to provide operational power to the device for dispensing air and/or sealant to the tire of the vehicle.

15. The device of claim 12, wherein the power supply cord has a two-wire power cable extending between the first end and the second end.

16. The device of claim 12, wherein the connector element comprises a connector housing enclosing the control module and a universal serial bus (USB) connector extending from the housing.

17. The device of claim 12, wherein the vehicle data communication port is a powered universal serial bus (USB), and the connector element comprises a first USB connector; and further comprising:
a housing enclosing the pressure source and the control module, wherein the housing comprises a second universal serial bus (USB) for receiving a second USB connector at the first end of the power supply cord.

18. The device of claim 17, wherein the power supply cord has a two-wire power cable extending between the control module and the second USB connector.

19. A method for dispensing air and/or sealant to a tire of a vehicle, the method comprising:
connecting a tire repair device to the tire;
connecting a connector element of a power supply cord of the tire repair device to a data communication port of the vehicle, the connector element including a control module; and
the control module in the connector element operating the tire repair device dispensing via the data communication port of the vehicle.

20. The method of claim 19, further comprising control module in the connector element automatically monitoring and/or controlling a tire inflation via data provided to the tire repair device by the vehicle via the data communication port.
